(19) United States
(12) Patent Application Publication
(10) Pub. No.: US 2024/0278244 A1
(43) Pub. Date: Aug. 22, 2024

(54) SEPTUM

(71) Applicant: HITACHI HIGH-TECH CORPORATION, Tokyo (JP)

(72) Inventors: Ryusuke KIMURA, Tokyo (JP); Motohiro YAMAZAKI, Tokyo (JP)

(21) Appl. No.: 18/570,161

(22) PCT Filed: Aug. 24, 2021
(86) PCT No.: PCT/JP2021/030979

§ 371 Date: Dec. 14, 2023

(51) Int. Cl. B01L 3/00

(52) U.S. Cl. CPC B01L 3/50853; B01L 2200/0689; B01L 2300/044; B01L 2300/0829

(57) ABSTRACT

A septum includes a plurality of tubular portions that are fittable to the inner sides of the opening portions of a plurality of arrayed containers, and slits that are formed in the respective bottom portions of the tubular portions. The septum adopts an insertion state where in a state where each of the tubular portions is fitted in the opening portion of the container, a thin tube that aspirates or discharges a liquid from within or into the container is inserted through the tubular portion into the container and a pulling out state where the thin tube is pulled out from within the container to the outside with respect to the tubular portion. When the pulling out state is shifted to the insertion state, the slit is opened by the elastic deformation of the tubular portion by pressing from the thin tube to allow the insertion of the thin tube.

### TECHNICAL FIELD

The present invention relates to a septum that seals a container, such as a well of a microplate and a microtube, in a state where a thin tube, such as a capillary, needle, and nozzle, can be inserted and pulled out.

### BACKGROUND ART

In the fields of biochemistry, medical diagnosis, and the like, electrophoresis is used for the analysis of a DNA, protein, or the like. As an apparatus that performs the electrophoresis, a capillary electrophoresis apparatus that includes a capillary is widely used. The capillary is a thin tube having a hollow structure, and has an inner layer that is formed of silica or the like to which a functional group having an electric charge is coupled. In the capillary electrophoresis apparatus, a liquid sample that is dispensed into a microplate or a microtube is qualitatively or quantitatively analyzed.

At the time of the analysis of the liquid sample, the end portion of the capillary is inserted into the liquid sample in a well of the microplate or the microtube. The capillary is used in a state where a migration medium is filled in its interior. When a voltage is applied to both ends of the capillary, an electroosmotic flow is formed in the capillary. The component in the liquid sample is aspirated into the capillary by the electroosmotic flow, and is separated at a moving speed based on the electric charge and the size while flowing in the capillary. The separated component is optically detected by a detection portion in the downstream in the capillary.

Typically, the capillary electrophoresis apparatus includes an autosampler that automatically performs an analyzing operation such as sampling. The capillary is fixed into the apparatus such that the end portion is opened downward. At the time of the analysis of the liquid sample, the microplate or the microtube in which the liquid sample is contained is prepared on a moving stage. The moving stage is provided to be movable in three dimensions with respect to the end portion of the capillary.

The microplate or the microtube in which the liquid sample is contained is conveyed by the moving stage in the horizontal direction to below the end portion of the capillary, and is then lifted or lowered in the vertical direction with respect to the end portion of the capillary. When the container is lifted from below with respect to the end portion of the capillary opened downward, the end portion of the capillary is inserted into the well of the microplate or the microtube, thereby enabling the aspiration of the liquid sample.

The liquid sample contained in the container is evaporated or exposed to a floating substance and the like in the air, for example, after preparation and during automatic analysis. When the liquid sample has a very small amount of approximately several hundred μL to 1.5 mL, the occurrence of the evaporation of the component significantly affects the analyzing result. In addition, the intrusion of the floating substance and the like in the air causes contamination. To prevent such the evaporation and contamination problems, a septum is mounted on the container in which the liquid sample is contained.

The septum has the function of sealing the container in which the sample or the like is contained in a state where the thin tube such as the capillary can be inserted and pulled out. For the microplate formed with a plurality of wells and a multiple consecutive microtube in which a plurality of microtubes are coupled to each other, the septum including a structure that seals a plurality of containers is used.

Typically, the septum is provided as a sheet-like cover by an elastomer having elasticity. As illustrated in FIG. 1, the typical septum includes a main body portion that is sheet-like as indicated by the reference numeral 10, hole portions as indicated by the reference numeral 20, and tubular portions that are bottomed as indicated by the reference numeral 30. The tubular portions are provided so as to be elastically fitted to the inner sides of the opening portions of the plurality of arrayed containers including the plurality of wells provided on the microplate and the plurality of microtubes coupled to each other.

The hole portion and the tubular portion form a penetration structure that penetrates the thin tube such as the capillary toward within the container. The bottom portion of the tubular portion is provided with a slit. The slit is provided such that when the thin tube such as the capillary is inserted, the slit is elastically deformed by pressing from the thin tube and is opened, and when the thin tube is pulled out, the slit is closed by the elastic restoring force. By the slit that is elastically opened and closed, the opening of the container is suppressed to be small while the insertion of the thin tube into the container is allowed.

Patent Literature 1 and Patent Literature 2 describe a sample container and a cap having a structure similar to the septum. In Patent Literature 1, a slit is provided as a cut (see paragraph 0047). In Patent Literature 2, a slit is formed in a cross shape (see paragraph 0039).

Patent Literature 3 describes a septum that has a recess in its center portion and a taper around the recess. In Patent Literature 3, provided is a structure in which when the taper of a cover comes into contact with the taper of the septum, an external force is applied toward an insertion portion at the cathode end of a capillary to close a hole (see paragraphs 0055, 0056).

### CITATION LIST

### Nonpatent Literature

Patent Literature 1: Japanese Unexamined Patent Application Publication No. 2020-160007
Patent Literature 2: Japanese Unexamined Patent Application Publication No. 2020-160020
Patent Literature 3: WO 2015/037308

### SUMMARY OF INVENTION

### Technical Problem

In the conventional typical septum, the slit in the bottom portion of the tubular portion is provided as the cut. After the tubular portion and the like are resin molded, the slit as the cut is formed by punching processing using a punch having a thin straight edge. When the thin tube such as the capillary is inserted into the slit as the cut, the inner walls of the slit are pressed and retreated by pressing from the thin tube, and the slit is slightly opened to allow the insertion of the thin tube.

Since the slit in the bottom portion of the tubular portion is provided as the cut by the punching processing, the conventional typical septum has some problems related to the manufacturing process of the septum and the characteristic of the slit.

At the conventional punching processing, the operation of mounting the resin molded septum on the processing jig and the operation of conveying the septum formed with the slit to the next step are required to be performed in the air. At the time of the punching processing, since processing chips are caused, the manufacturing in the clean room is difficult. In addition, anti-rust oil, rust, and the like may adhere to the punch used for the processing. When the septum being manufactured is exposed to the air and a foreign substance, the septum may be contaminated. For that, after the punching processing, the cleaning step for cleaning the septum is incorporated.

In addition, at the time of the conventional punching processing, the individual slits are formed at one time in the bottom portions of the plurality of regularly arrayed tubular portions. At the time of such the processing, the perforation defects, misalignments, dimension defects, and the like of the slits may be caused although few in number. In addition, in the cleaning step, since the force is likely to be applied to the protruding tubular portion, the end portion of the slit as the cut may be torn. For that, after the cleaning of the septum, the slit inspection step for inspecting all the dimensions, tears, and the like of the slits is incorporated.

However, when the cleaning step and the slit inspection step are incorporated into the manufacturing process of the septum, there is a problem that the number of steps and the facility cost are increased to increase the manufacturing cost of the septum. In addition, in the manufacturing process for forming the regularly arrayed slits at one time and the manufacturing process for cleaning the septum after processing the slits, when the defects are caused even in some of the plurality of slits, the entire septum becomes a defective product, so that there is a problem that the yield in the product unit is deteriorated. Patent Literatures 1 to 3 do not disclose such the slit as the cut, the problem due to the slit as the cut, and its solving method.

Accordingly, an object of the present invention is to provide a septum that can suppress a manufacturing cost and improve a yield on the basis of the peripheral structure of a slit into which a thin tube such as a capillary is inserted.

### Solution to Problem

To solve the above problems, a septum according to the present invention includes a plurality of tubular portions that are fittable to the inner sides of the opening portions of a plurality of arrayed containers, and slits that are formed in the respective bottom portions of the tubular portions. The septum adopts an insertion state where in a state where each of the tubular portions is fitted in the opening portion, a thin tube that aspirates or discharges a liquid from within or into the container is inserted through the tubular portion into the container and a pulling out state where the thin tube is pulled out from within the container to the outside with respect to the tubular portion. When the pulling out state is shifted to the insertion state, the slit is opened by the elastic deformation of the tubular portion by pressing from the thin tube to allow the insertion of the thin tube. When the insertion state is shifted to the pulling out state, the slit is closed by the elastic force of the tubular portion to seal the container. In the septum, the tubular portion has a protrusion that protrudes from the side surface of the tubular portion to the outside in the radial direction. In a state where the tubular portion is removed from the opening portion, the slit is provided in an opened shape in which the inner walls of the slit are not abutted onto each other, and in a state where the tubular portion is fitted to the inner side of the opening portion, the protrusion receives pressing from the inner wall of the container, and the slit is closed by the elastic deformation of the tubular portion by the pressing to seal the container.

### Advantageous Effects of Invention

In accordance with the septum according to the present invention, the manufacturing cost can be suppressed and the yield can be improved on the basis of the peripheral structure of the slit into which the thin tube such as the capillary is inserted.

### BRIEF DESCRIPTION OF DRAWINGS

FIG. 1 is a perspective view illustrating a septum according to an embodiment of the present invention and a microplate;

FIG. 2 is a cross-sectional view illustrating a state where the septum according to the embodiment of the present invention is mounted on the microplate;

FIG. 3 is a cross-sectional view illustrating the structure of a conventional typical septum;

FIG. 4 is a perspective view of a tubular portion of the conventional typical septum, seen from below;

FIG. 5 is a cross-sectional view illustrating the structure of the septum according to the present embodiment;

FIG. 6 is a perspective view of a tubular portion of the septum according to the present embodiment, seen from bel ow;

FIG. 7A is a cross-sectional view illustrating the sealing method (initial state) of a container by the septum according to the embodiment of the present invention;

FIG. 7B is a cross-sectional view illustrating the sealing method (intermediate state) of the container by the septum according to the embodiment of the present invention;

FIG. 7C is a cross-sectional view illustrating the sealing method (sealing state) of the container by the septum according to the embodiment of the present invention;

FIG. 8A is a bottom view of the tubular portion of the septum illustrating the shape example (rectangular shape) of a slit;

FIG. 8B is a bottom view of the tubular portion of the septum illustrating the shape example (elliptic shape) of the slit;

FIG. 8C is a bottom view of the tubular portion of the septum illustrating the shape example (oval shape) of the slit;

FIG. 8D is a bottom view of the tubular portion of the septum illustrating the shape example (rhombic shape) of the slit;

FIG. 8E is a bottom view of the tubular portion of the septum illustrating the shape example (mouth shape) of the slit;

FIG. 8F is a bottom view of the tubular portion of the septum illustrating the shape example (spear shape) of the slit;

FIG. 9A is a perspective view of the tubular portion of the septum illustrating the shape example (rib shape) of a protrusion, seen from below;

FIG. 9B is a perspective view of the tubular portion of the septum illustrating the shape example (auxiliary) of the protrusion, seen from below;

FIG. 9C is a perspective view of the tubular portion of the septum illustrating the shape example (vane shape) of the protrusion, seen from below; and

FIG. 10 is a perspective view illustrating the septum according to the embodiment of the present invention and a multiple consecutive microtube.

### DESCRIPTION OF EMBODIMENTS

Hereinbelow, a septum according to an embodiment of the present invention will be described with reference to the drawings. It should be noted that the following structures shared in the respective drawings are indicated by the same reference numerals, and the overlapped description is omitted.

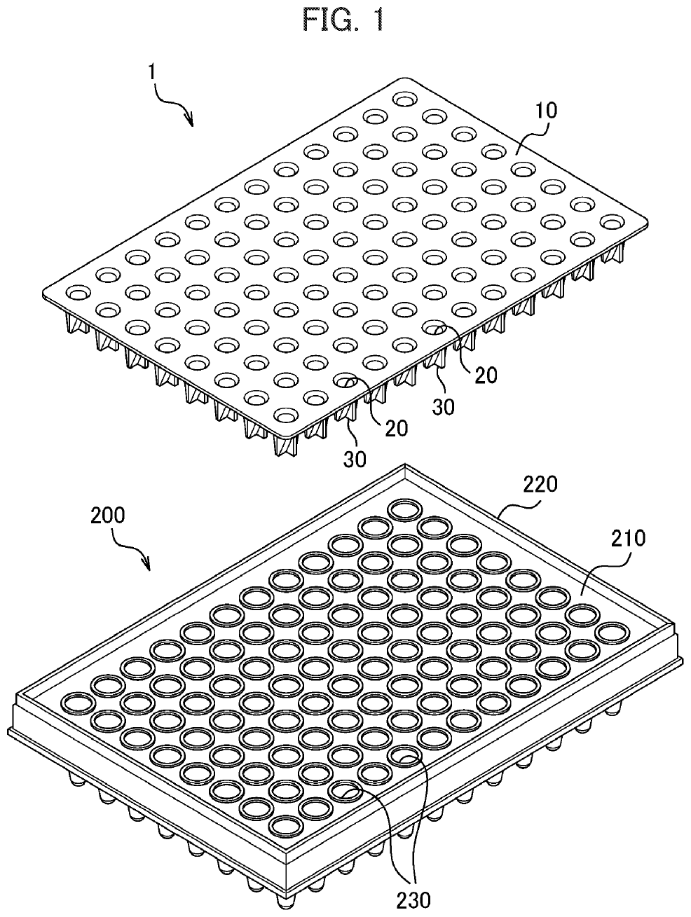

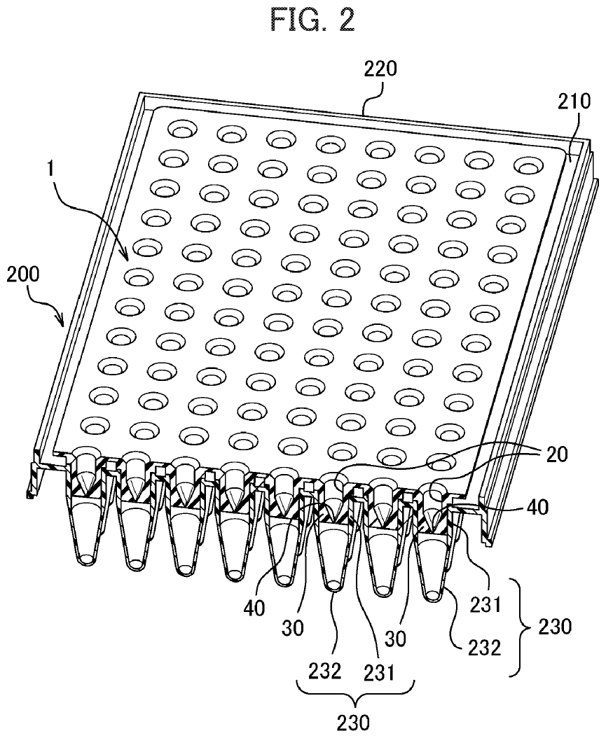

FIG. 1 is a perspective view illustrating the septum according to an embodiment of the present invention and a microplate. FIG. 2 is a cross-sectional view illustrating a state where the septum according to the embodiment of the present invention is mounted on the microplate.

FIGS. 1 and 2 illustrate, as an example of the septum according to the present embodiment, a septum 1 for the microplate and a microplate 200 on which the septum 1 is mounted.

The microplate 200 is used as a container for analysis, examination, experiment, and the like. The microplate 200 is made of a resin or the like having high rigidity, and is provided in a substantially rectangular plate shape. As the material of the microplate 200, polyolefin, such as polystyrene and polypropylene, is used. Although the microplate 200 is typically formed of the resin, the microplate 200 may be formed of glass or the like.

In FIG. 1, a concave portion 210 is formed on the upper surface of the microplate 200. The concave portion 210 has a rectangular shape in plan view of the microplate 200, and is formed over the substantially entire upper surface. The periphery of the concave portion 210 is surrounded by an outer frame 220 in a thin plate shape. The upper surface side of the microplate 200 is wall thinned at a substantially uniform thickness by leaving the outer frame 220 in its periphery, thereby forming the concave portion 210 in a dish shape.

On the concave portion 210 of the microplate 200, a plurality of wells 230 are formed. The well 230 has a circular shape in plan view of the microplate 200, and is provided as a recess in a substantially columnar shape that is tapered. The well 230 is opened to the bottom surface of the concave portion 210. The wells 230 are arrayed on the bottom surface of the concave portion 210 in a matrix to be spaced from each other.

As illustrated in FIG. 2, the well 230 includes an upper portion 231 provided in a cylindrical shape, and a lower portion 232 provided in a bottomed cylindrical shape that is reduced in diameter downward in a taper shape. In the inside of the upper portion 231, a space in a columnar shape is formed. In the inside of the lower portion 232, a space in a substantially inverted circular truncated conical shape that is reduced in diameter downward in a taper shape is formed.

The space in the interior of the well 230 functions as the container, and a desired liquid or the like is introduced into the space. Examples of the liquid include a liquid sample, a solution in which a solid sample is dissolved, a dispersion liquid in which a solid sample such as powder is dispersed, a buffer, a standard sample, and the like. The liquid itself to be analyzed dispensed into the well 230, the solution and the dispersion liquid containing a component to be analyzed, a reactant in liquid form, a cultural substance in liquid form, and the like are provided for various analyses, examinations, experiments, and the like.

In FIGS. 1 and 2, the microplate 200 is a 96-well microplate in which 96 wells 230 in total with 8 rows and 12 columns are formed. For example, the well 230 is provided to have a volume of 100 to 400 μL, an inside diameter of 5 to 8 mm, a depth of 6 to 20 mm, and the like. Note that the volume, inside diameter, outside diameter, depth, mutual interval, and the like of the well 230 are different according to the number of wells, the well array, and the like of the microplate 200.

It should be noted that although in FIGS. 1 and 2, the concave portion 210 is provided on the upper surface side of the microplate 200 and the well 230 is provided as the recess in a substantially columnar shape that is tapered, the shapes of the microplate 200 and the well 230 are not particularly limited as long as the shapes of the microplate 200 and the well 230 correspond to the septum 1. For example, the well 230 may be provided as the recess in a substantially columnar shape. The bottom portion of the well 230 may be any one of a flat bottom, circular bottom, U-shaped bottom, V-shaped bottom, and the like.

The microplate 200 has a use as the container that sets the sample to an automatic analyzer including an autosampler. Specific examples of the automatic analyzer include a capillary electrophoresis apparatus, a high-speed liquid chromatography (High Performance Liquid Chromatography: HPLC) apparatus, and a biochemical analyzer, a chemical analyzer, an optical analyzer, and the like that perform other component analysis, reaction analysis, and the like.

The automatic analyzer includes, as the apparatus that configures the autosampler, a thin tube that aspirates or discharges the liquid from within or into the container, such as the well 230 of the microplate 200, the microtube, and a micro vial, and a moving stage or the like that relatively mutually moves the container, such as the well 230 of the microplate 200, the microtube, and the micro vial and the end portion of the thin tube. Like a nozzle 400 illustrated in FIG. 4A, the thin tube is inserted into the container.

The thin tube that aspirates or discharges the liquid is installed in the automatic analyzer such that the end portion is opened downward. The thin tube may include only the function of aspirating the liquid from within the container, such as the well 230 of the microplate 200, the microtube, and the micro vial, may include only the function of discharging the liquid into these containers, and may include both of these functions.

Specific examples of the thin tube include a capillary that is long, has flexibility, and is used for a separation operation such as electrophoresis, a metal needle that has the function of aspirating or discharging the liquid, a resin nozzle that has flexibility or high rigidity and has the function of aspirating or discharging the liquid, a metal nozzle that has the function of aspirating or discharging the liquid, and the like.

The moving stage may relatively move the container, such as the well 230 of the microplate 200, the microtube, and the micro vial, with respect to the end portion of the thin tube fixed into the apparatus, and may relatively move the end portion of the thin tube and the entire thin tube with respect to the container fixed into the apparatus. The relative movement by the moving stage is performed in the horizontal direction and the vertical direction.

As illustrated in FIGS. 1 and 2, the septum 1 according to the present embodiment includes a main body portion 10 that is formed to be sheet-like, a plurality of hole portions 20 that penetrate through the main body portion 10 upward and downward, tubular portions 30 that are bottomed and are formed so as to protrude downward from the respective peripheries of the hole portions 20 on the lower surface side of the main body portion 10, and slits 40 that are formed in the respective bottom portions of the tubular portions 30.

In FIGS. 1 and 2, the septum 1 is provided to be for the 96-well microplate. The septum 1 for the 96-well microplate includes 96 hole portions 20 and 96 tubular portions 30 in total with 8 rows and 12 columns at the positions corresponding to the wells 230 of the microplate 200. In addition, the slits 40 are provided in the respective bottom portions of the tubular portions 30.

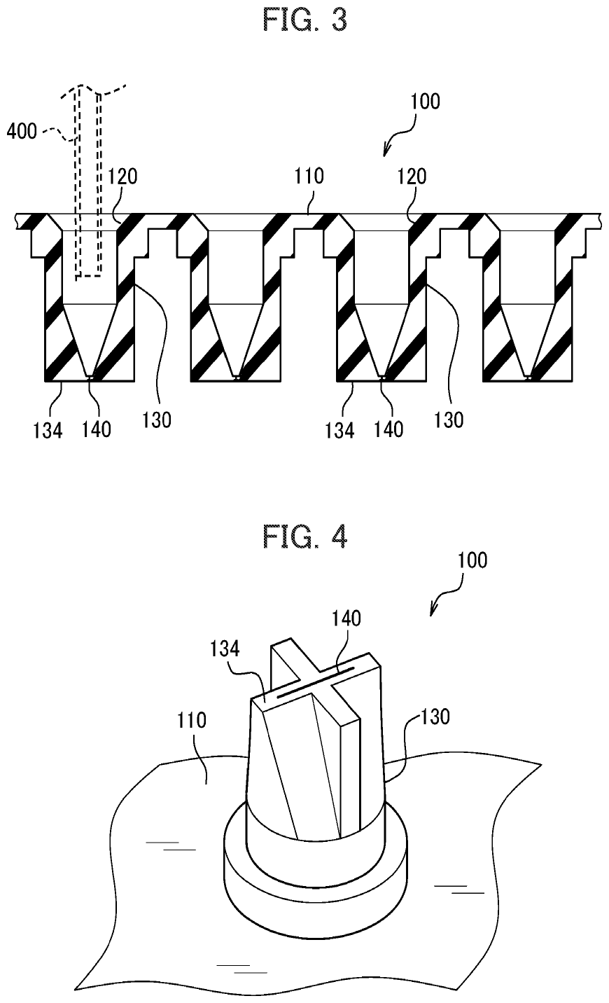

The septum 1 has the function of sealing the well 230 of the microplate 200 in a state where the thin tube, such as the capillary, needle, and nozzle 400 (see FIG. 3), of the automatic analyzer can be inserted and pulled out. For example, after the sample is introduced into the well 230 of the microplate 200, and before the microplate 200 is set to the automatic analyzer, as illustrated in FIG. 2, the septum 1 is mounted on the upper surface side of the microplate 200.

The main body portion 10, the hole portions 20, and the tubular portions 30 of the septum 1 are integrally resin molded by an elastomer that exhibits elasticity. Examples of the septum 1 include silicone rubber, fluorocarbon rubber, ethylene propylene diene rubber (EPDM), and the like. The tubular portion 30 is provided to have an elastic modulus to the degree that the tubular portion 30 is easily elastically deformed with respect to pressing when the tubular portion 30 is inserted into the well 230 and pressing from the thin tube of the automatic analyzer.

As a method for resin molding the septum 1, compression molding, transfer molding, and the like are used. The compression molding is a method by which the resin material is introduced into a molding die, and is pressed under heating for molding. The transfer molding is a method by which the heated resin material is injected into the molding die, and is pressurized for molding. As the method of the resin molding, the compression molding is preferable in that the structure of the molding die is simple and the productivity is high.

As illustrated in FIGS. 1 and 2, the main body portion 10 can be provided to have a size that can be accommodated in the concave portion 210 of the microplate 200. The length and width of the main body portion 10 can be provided to be smaller than the length and the width of the concave portion 210. The thickness of the main body portion 10 can be provided to be equal to the depth of the concave portion 210 or to be smaller than the depth of the concave portion 210.

When such the main body portion 10 is provided, the mounting of the septum 1 onto the concave portion 210 of the microplate 200 and the removal of the septum 1 from the concave portion 210 can be easily performed by using the space around the concave portion 210. In addition, it becomes easy to mount a cover or a retainer, as needed, to the upper side of the septum 1 mounted on the concave portion 210 of the microplate 200.

Here, the structure of the septum according to the present embodiment and the sealing method of the container by the septum according to the present embodiment will be described together with the structure of a conventional typical septum and the sealing method of the container by the conventional typical septum.

FIG. 3 is a cross-sectional view illustrating the structure of the conventional typical septum. FIG. 4 is a perspective view of the tubular portion of the conventional typical septum, seen from below.

As illustrated in FIGS. 3 and 4, a conventional typical septum 100 includes a main body portion 110 that is formed to be sheet-like, a plurality of hole portions 120 that penetrate through the main body portion 110 upward and downward, tubular portions 130 that are bottomed and are formed so as to protrude downward from the respective peripheries of the hole portions 120 on the lower surface side of the main body portion 110, and slits 140 that are formed in the respective bottom portions of the tubular portions 130.

Like the septum 1 according to the present embodiment, the conventional typical septum 100 has the function of sealing the well 230 of the microplate 200 in a state where the thin tube, such as the capillary, needle, and nozzle, of the automatic analyzer can be inserted and pulled out. The septum 100 is mounted on the upper surface side of the microplate 200.

In the conventional typical septum 100, the main body portion 100, the hole portions 120, and the tubular portions 130 are integrally resin molded by an elastomer that exhibits elasticity. The hole portions 120 and the tubular portions 130 are provided on the main body portion 110 in a matrix to be spaced from each other so as to correspond to the wells 230 of the microplate 200. As illustrated in FIG. 3, the hole portion 120 and the tubular portion 130 form a penetration structure that penetrates through the septum 100 upward and downward.

The tubular portion 130 is provided to be fittable to the inner side of the opening portion of the well 230 provided on the microplate 200. When the septum 100 is mounted on the microplate 200, each of the tubular portions 130 is inserted into each of the wells 230. The outside diameter of the tubular portion 130 is provided to be equal to the inside diameter of the well 230 or to be slightly larger than the inside diameter of the well 230. In addition, the tubular portion 130 is provided so as to be easily elastically deformed by pressing from the inner wall of the well 230, and to be pressed onto the inner wall of the well 230 by the elastic restoring force.

For that, when the tubular portion 130 is inserted into the well 230, the tubular portion 130 receives pressing from the inner wall of the opening portion of the well 230 toward the center axis side of the tubular portion 130, is slightly elastically deformed so as to be collapsed in the radial direction, and is fitted in the opening portion of the well 230. After the tubular portion 130 is inserted into the well 230, the tubular portion 130 is pressed onto the inner wall of the well 230 by the elastic restoring force, and causes a friction force with respect to the force that pulls out the tubular portion 130 from within the well 230. The tubular portion 130 is elastically fitted in this way, so that the septum 100 is removably fixed to the microplate 200.

As illustrated in FIGS. 3 and 4, the slit 140 is formed in a bottom portion 134 of the tubular portion 130. The slit 140 forms a through hole that penetrates through the bottom portion 134 of the tubular portion 130 upward and downward. In a state where the septum 100 is mounted on the microplate 200, the thin tube, such as the capillary, needle, and nozzle 400, of the automatic analyzer is passed through the inside of the hole portion 120 and the tubular portion 130, and is inserted through the slit 140. It should be noted that in FIG. 3, the nozzle 400 as an example of the thin tube is indicated by dashed lines.

The conventional typical septum 100 adopts an insertion state where the thin tube, such as the capillary, needle, and nozzle 400, of the automatic analyzer is inserted through the tubular portion 130 into the well 230 of the microplate 200 and a pulling out state where the thin tube is pulled out from the well 230 of the microplate 200 to the outside with respect to the tubular portion 130. The slit 140 that is formed in the bottom portion 134 of the tubular portion 130 is opened and closed by the elastic deformation.

In the automatic analyzer, when the liquid in the well 230 is aspirated by the thin tube or the liquid is discharged into the well 230 by the thin tube, the relative movement of the predetermined well 230 of the microplate 200 and the end portion of the thin tube is driven. First, the relative movement in the horizontal direction is driven until the predetermined well 230 is positioned to below the end portion of the thin tube. Thereafter, the relative movement in the vertical direction is driven.

When in the pulling out state, the relative movement in the vertical direction is driven in the direction in which the well 230 and the end portion of the thin tube are brought closer to each other, the end portion of the thin tube is penetrated through the hole portion 120 and the tubular portion 130 in the axial direction, and is inserted through the slit 140 into the well 230. On the other hand, when in the insertion state, the relative movement in the vertical direction is driven in the direction in which the well 230 and the end portion of the thin tube are separated from each other, the end portion of the thin tube is pulled out from within the well 230 to the outside with respect to the tubular portion 130 and the hole portion 120.

In the conventional typical septum 100, when the pulling out state is shifted to the insertion state, the slit 40 is opened by the elastic deformation of the tubular portion 130 by pressing from the thin tube to allow the insertion of the thin tube. On the other hand, when the insertion state is shifted to the pulling out state, or in the pulling out state before insertion, the slit 140 is closed by the elastic force of the bottom portion 134 of the tubular portion 130 to seal the well 230.

As illustrated in FIG. 4, in the conventional typical septum 100, the slit 140 is provided as a straight cut in the bottom portion 134 of the tubular portion 130. The slit 140 as the cut is formed by punching processing that penetrates a punch having a thin straight edge through the bottom portion 134 of the tubular portion 130. In addition, the side surface of the tubular portion 130 does not protrude toward the outside in the radial direction, and has a flat shape that slide contacts with the inner wall of the well 230.

When the thin tube of the automatic analyzer is not inserted into the slit 140 as the cut, and in a non-load state where a load by pressing from the thin tube is not applied, the inner walls of the cut come into contact with each other, and the slit 140 is closed substantially completely. On the other hand, when the thin tube is inserted, the inner walls of the cut are pressed and retreated by pressing from the thin tube, and the cut is slightly opened to the degree that the thin tube is inserted through the bottom portion 134 of the tubular portion 130 by the elastic deformation of the bottom portion 134 of the tubular portion 130. When the thin tube is pulled out, the cut returns to a state where the cut is closed substantially completely by the elastic restoring force of the bottom portion 134 of the tubular portion 130.

In accordance with such the conventional typical septum 100, the well 230 in which the sample is contained can be sealed by the slit 140 elastically opened and closed in a state where the thin tube can be inserted and pulled out. For that, while the insertion of the thin tube into the well 230 and the pulling out of the thin tube from within the well 230 are allowed, the evaporation of the component from within the well 230 and the intrusion of a contaminant into the well 230 are suppressed. Since the sample introduced into the well 230 often has a small amount, when the evaporation proceeds before analysis and during analysis, the end portion of the thin tube can be exposed to the gas phase, and the concentration of the sample can be changed. In addition, a floating substance and the like in the air can be intruded to cause contamination. However, when the well 230 is sealed by the septum 100, accurate and stable analysis is enabled.

On the contrary, the septum 1 according to the present embodiment is different from the conventional typical septum 100 in the shape and structure of the tubular portion 30 that is bottomed and is formed to protrude downward of the main body portion 10 and the shape and structure of the slit 40 that is formed in the bottom portion 34 of the tubular portion 30. In addition, in relation to the difference between these shapes and structures, the sealing method of the container and the manufacturing process of the septum are different.

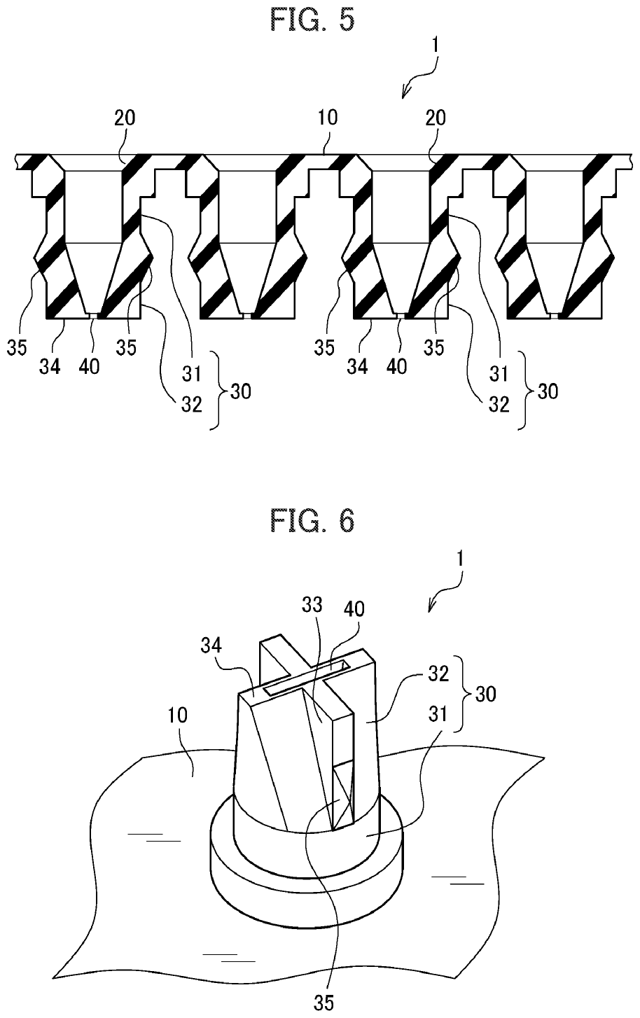

FIG. 5 is a cross-sectional view illustrating the structure of the septum according to the present embodiment. FIG. 6 is a perspective view of the tubular portion of the septum according to the present embodiment, seen from below.

As illustrated in FIGS. 5 and 6, unlike the conventional typical septum 100, in the septum 1 according to the present embodiment, the slit 40 in the bottom portion 34 of the tubular portion 30 is provided in a previously opened shape. In addition, a protrusion 35 is provided on the side surface of the tubular portion 30.

As illustrated in FIGS. 1 and 2, the hole portions 20 and the tubular portions 30 are provided on the main body portion 10 in a matrix to be spaced from each other so as to correspond to the wells 230 of the microplate 200. As illustrated in FIG. 5, the hole portion 20 and the tubular portion 30 form a penetration structure that penetrates through the septum 1 upward and downward.

The tubular portion 20 has a circular shape in plan view of the main body portion 10, and is provided as a through hole in a substantially inverted circular truncated conical shape that penetrates through the main body portion 10 upward and downward. One end of the hole portion 20 is opened to the upper surface of the main body portion 10. The other end of the hole portion 20 is opened, on the lower surface side of the main body portion 10, to the inside of the tubular portion 30. The inside diameter of the hole portion 20 is provided to be equal to the inside diameter of the well 230 or to be smaller than the inside diameter of the well 230. The hole portion 20 may be provided as a through hole in a substantially columnar shape that penetrates through the main body portion 10 upward and downward.

The tubular portion 30 has a circular shape in plan view of the main body portion 10, and protrudes downward in a bottomed cylindrical shape from the periphery of the hole portion 20 on the lower surface side of the main body portion 10. The tubular portion 30 is arranged concentrically with the hole portion 20. The inner circumference wall of the tubular portion 30 continues downward from the lower end of the inner circumference wall of the hole portion 20. By the hole portion 20 and the tubular portion 30, the penetration structure in a recess shape that penetrates through the septum 1 upward and downward is formed.

The tubular portion 30 includes an upper tubular portion 31 provided in a cylindrical shape, and a lower tubular portion 32 provided in a bottomed cylindrical shape that is tapered. The upper tubular portion 31 protrudes downward in a cylindrical shape from the periphery of the hole portion 20 on the lower surface side of the main body portion 10. The lower tubular portion 32 protrudes downward in a taper shape from the lower end of the upper tubular portion 31.

In the inside of the upper tubular portion 31, a space in a columnar shape is formed. In the inside of the lower tubular portion 32, a space that is substantially similar to the outside shape, and is narrowed in width downward in a taper shape is formed. By the shape that is narrowed in width downward in a taper shape, the thin tube, such as the capillary, needle, and nozzle 400, of the automatic analyzer is suitably guided to the slit 40 in the bottom portion 34 of the tubular portion 30.

In FIG. 6, the lower tubular portion 32 is provided in a shape in which both outer sides in the radial direction of the bottomed cylindrical shape are diagonally cut away so as to have a substantially V-shape in side view of the tubular portion 30. On the cut-away end side, the bottom portion 34 of the lower tubular portion 32 is formed as a plane that is substantially perpendicular to the center axis of the tubular portion 30. The bottom portion 34 of the lower tubular portion 32 has a rectangular shape in bottom view of the tubular portion 30. The bottom portion 34 of the tubular portion 32 is provided on the diameter line of the end surface on the cut-away end side of the tubular portion 30 in a rectangular shape having long sides having the same length as the diameter.

The lower tubular portion 32 has inclined side surfaces by diagonally cutting away both outer sides in the radial direction. A rib 33 is provided on the inclined side surfaces of the lower tubular portion 32 so as to protrude to the outside. The rib 33 is provided to be line symmetrical on both sides with respect to the center axis in the longitudinal direction of the bottom portion 34 of the lower tubular portion 32. In side view of the tubular portion 30, the rib 33 extends from the lower end portion of the lower tubular portion 32 at which the bottom portion 34 of the lower tubular portion 32 is positioned to the upper end portion of the lower tubular portion 32 at which the boundary with the upper tubular portion 31 is positioned, and is formed as a protrusion having a substantially uniform width.

In bottom view of the tubular portion 30, the rib 33 extends from the center portion of the respective long sides of the bottom portion 34 of the lower tubular portion 32 to both outer sides toward the direction perpendicular to the longitudinal direction of the bottom portion 34 of the lower tubular portion 32. In bottom view of the tubular portion 30, the rib 33 extends so as to intersect the center portion of the bottom portion 34 of the lower tubular portion 32 in a cross shape. The rib 33 is arranged so as to sandwich the center portion of the slit 40 formed in the bottom portion 34 of the lower tubular portion 32 from both outer sides in the lateral direction of the slit 40.

That is, in the lower tubular portion 32 provided with the rib 33, the respective both outer sides in the radial direction of the bottomed cylindrical shape are provided in a shape in which both of the left and right sides are diagonally wall thinned by leaving the rib 33 on the center side. For that, the outside diameter in the radial direction of the lower tubular portion 32 including the rib 33 is equal to the outside diameter of the upper tubular portion 31. When the tubular portion 30 is inserted into the well 230 of the microplate 200, the outer side surfaces of the rib 33 are provided so as to slide contact with the inner wall of the well 230 together with the side surface of the upper tubular portion 31.

When such the rib 33 is provided, the elastic fitting ability of the tubular portion 30 with respect to the opening portion of the well 230 of the microplate 200 and the slide contacting ability with respect to the inner wall of the opening portion of the well 230 can be ensured, so that while the lower portion side of the tubular portion 30 is provided to be wall thinned, the septum 1 can be stably removably fixed to the microplate 200. When the lower portion side of the tubular portion is reduced in thickness to be wall thinned, the appropriate flexibility and rigidity are obtained, so that when the well 230 is sealed, the bottom portion 34 of the lower tubular portion 32 around the slit 40 can be suitably elastically deformed.

Like the case of the conventional typical septum 100, the tubular portions 30 are provided to be fittable to the inner sides of the opening portions of the plurality of wells 230 provided on the microplate 200. When the septum 1 is mounted on the microplate 200, each of the tubular portions 30 is inserted into each of the wells 230. The outside diameter of the region except for the protrusions 35 of the tubular portion 30 is provided to be equal to the inside diameter of the well 230 or to be slightly larger than the inside diameter of the well 230. In addition, the tubular portion 30 and the protrusions 35 are provided so as to be easily elastically deformed by pressing when the tubular portion 30 and the protrusions 35 are inserted into the well 230, and to be pressed onto the inner wall of the well 230 by the elastic restoring force.

For that, when the tubular portion 30 and the protrusions 35 are inserted into the well 230, the tubular portion 30 and the protrusions 35 receive pressing from the inner wall of the opening portion of the well 230 toward the center axis side of the tubular portion 30, are slightly elastically deformed so as to be collapsed in the radial direction, and are fitted in the opening portion of the well 230. After the tubular portion 30 and the protrusions 35 are inserted into the well 230, the tubular portion 30 and the protrusions 35 are pressed onto the inner wall of the well 230 by the elastic restoring force, and cause a friction force with respect to the force that pulls out the tubular portion 30 from within the well 230. The tubular portion 30 is elastically fitted in this way, so that the septum 1 is removably fixed to the microplate 200.

As illustrated in FIG. 6, the slit 40 is formed in the bottom portion 34 of the tubular portion 30. The slit 40 forms a through hole that penetrates through the bottom portion 34 of the tubular portion 30 upward and downward. In a state where the septum 1 is mounted on the microplate 200, the thin tube, such as the capillary, needle, and nozzle 400, of the automatic analyzer is passed through the inside of the hole portion 20 and the tubular portion 30, and is inserted through the slit 40.

Like the conventional typical septum 100, the septum 1 according to the present embodiment adopts an insertion state where the thin tube, such as the capillary, needle, and nozzle 400, of the automatic analyzer is inserted through the tubular portion 30 into the well 230 of the microplate 200 and a pulling out state where the thin tube is pulled out from the well 230 of the microplate 200 to the outside with respect to the tubular portion 30. The slit 40 that is formed in the bottom portion 34 of the tubular portion 30 is opened and closed by the elastic deformation.

Like the conventional typical septum 100, the septum 1 according to the present embodiment is provided such that when the pulling out state is shifted to the insertion state, the slit 40 is opened by the elastic deformation of the tubular portion 30 by pressing from the thin tube to allow the insertion of the thin tube. On the other hand, the septum 1 according to the present embodiment is provided such that when the insertion state is shifted to the pulling out state, or in the pulling out state before insertion, the slit 40 is closed by the elastic force of the tubular portion 30 to seal the well 230.

As illustrated in FIG. 6, in the septum 1 according to the present embodiment, the slit 40 is provided in the bottom portion 34 of the tubular portion 30 in a previously opened shape. The slit 40 is resin molded by using the molding die that molds the slit 40 into an opened shape. The slit 40 is in an opened shape in which the inner walls of the slit 40 are not abutted onto each other in a state where the tubular portion 30 is removed from the opening portion of the well 230 or the like, that is, in a non-load state where a load from the outside is not applied to the tubular portion 30.

In addition, in the septum 1 according to the present embodiment, the protrusions 35 are provided on the side surfaces of the tubular portion 30. The protrusions 35 protrude from the side surfaces of the tubular portion 30 to the outside in the radial direction. The protrusions 35 are provided to be symmetrical on both outer sides in the radial direction with respect to the center axis of the tubular portion 30. The protrusions 35 are integrally resin molded together with the tubular portion 30 by an elastomer that exhibits elasticity.

In FIG. 6, the slit 40 is provided such that in bottom view of the tubular portion 30, the longitudinal direction of the slit 40 is parallel to the longitudinal direction of the bottom portion 34 of the lower tubular portion 32. By such the arrangement, the periphery of the slit 40 is surrounded by the bottom portion 34 of the lower tubular portion 32 that is formed of the elastomer having a nearly uniform thickness.

The protrusions 35 are provided on the lower portion sides close to the bottom portion 34 of the lower tubular portion 32, of the side surfaces of the tubular portion 30, and on the outer side surfaces of the rib 33. In bottom view of the tubular portion 30, the protrusions 35 are arranged on both sides perpendicular to the longitudinal direction of the bottom portion 34 of the lower tubular portion 32 with respect to the center portion of the bottom portion 34 of the lower tubular portion 32. The protrusions 35 are arranged to be line symmetrical on both outer sides with respect to the center axis in the longitudinal direction of the slit 40 so as to sandwich the center side of the slit 40 from both outer sides in the lateral direction.

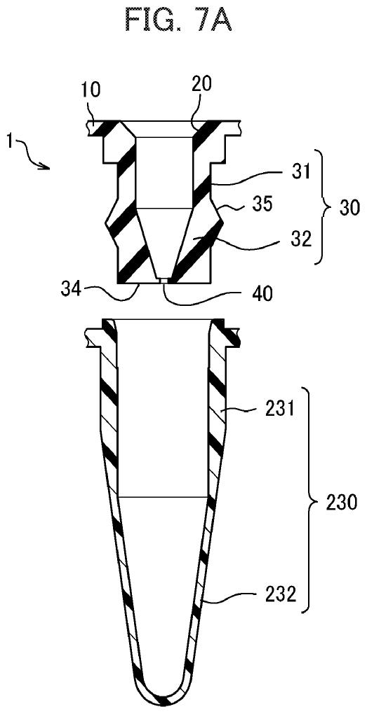

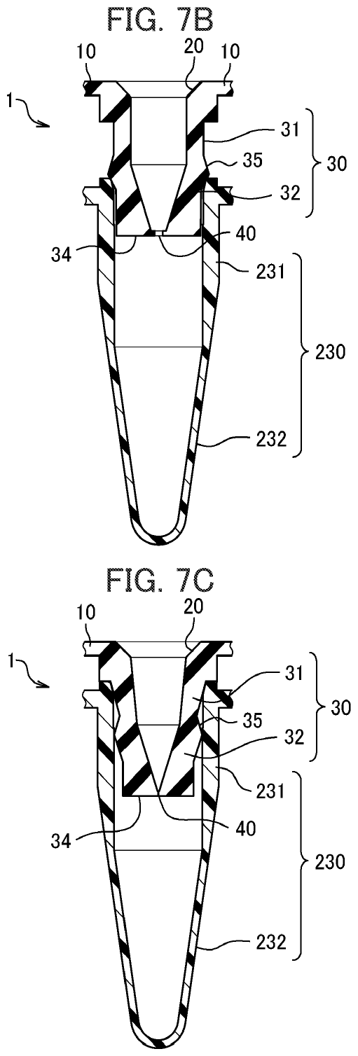

FIGS. 7A to 7C are cross-sectional views illustrating the sealing method of the container by the septum according to the embodiment of the present invention.

FIGS. 7A to 7C schematically illustrate a state where the tubular portion 30 is inserted into the well 230 of the microplate 200. FIG. 7A illustrates an initial state before the insertion of the tubular portion 30. FIG. 7B illustrates an intermediate state during the insertion of the tubular portion 30. FIG. 7C illustrates a sealing state after the insertion of the tubular portion 30.

As illustrated in FIG. 7A, in the initial state, the slit 40 in the bottom portion 34 of the tubular portion 30 is opened in a shape in which the slit 40 is resin molded. The tubular portion 30 is in a state where the tubular portion 30 is removed from the opening portion of the well 230, and is in a non-load state where a load from the outside is not applied. The slit 40 is in a state where the inner walls are not abutted onto each other, and is in a state where the function of sealing the container is hardly obtained.

As illustrated in FIG. 7B, in the intermediate state, the tubular portion 30 is inserted to the height of the protrusions 35 with respect to the opening portion of the well 230. The outside diameter of the region except for the protrusions 35 of the tubular portion 30 is provided to be equal to the inside diameter of the well 230 or to be slightly larger than the inside diameter of the well 230. On the other hand, the protrusions 35 protrude from the side surfaces of the tubular portion 30 to the outside in the radial direction. For that, when the septum 1 is mounted on the microplate 200, the tubular portion 30 is inserted into the well 230 while the protrusions 35 are pressed into the inside.

As illustrated in FIG. 7C, in the sealing state, the substantially entire tubular portion 30 is inserted into the opening portion of the well 230. The tubular portion 30 is in a state where the tubular portion 30 is elastically fitted to the inner side of the opening portion of the well 230. The protrusions 35 receive pressing from the inner wall of the opening portion of the well 230, and elastically deform the tubular portion 30 such that the tubular portion 30 is collapsed in the radial direction. The tubular portion 30 is elastically deformed so as to be collapsed in the radial direction to close the slit 40. The slit 40 is brought into a state where the inner walls are abutted onto each other to be closed, so that the function of sealing the container is obtained.

As illustrated in FIG. 6, the slit 40 is provided such that the longitudinal direction of the slit 40 is parallel to the longitudinal direction of the bottom portion 34 of the lower tubular portion 32. The protrusions 35 are arranged so as to sandwich the center side of the slit 40 from both outer sides in the lateral direction in bottom view of the tubular portion 30. For that, when the protrusions 35 receive pressing from the inner wall of the opening portion of the well 230, the bottom portion 34 of the lower tubular portion 32 is elastically deformed so as to close the slit 40 from both outer sides in the lateral direction, thereby closing the slit 40 provided in a previously opened shape.

The slit 40 can be provided such that at least the center sides of the inner walls are abutted onto each other in a state where the tubular portion 30 is elastically fitted to the inner side of the opening portion of the well 230, that is, in a state where the protrusions 35 receive pressing from the inner wall of the opening portion of the well 230. The closing ability by the elastic deformation of the slit 40 can be adjusted by adjusting the shape, length, and width of the slit 40 and the shape, length, width, height, arrangement, and the like of the protrusion 35.

In the automatic analyzer, when the liquid in the well 230 is aspirated by the thin tube or the liquid is discharged into the well 230 by the thin tube, the thin tube is inserted into the tubular portion 30 in the sealing state as illustrated in FIG. 7C. When the pulling out state is shifted to the insertion state, the slit 40 that is substantially closed by the elastic deformation by pressing from the inner wall of the opening portion of the well 230 is opened by the elastic deformation by pressing from the thin tube. On the other hand, when the insertion state is shifted to the pulling out state, or in the pulling out state before insertion, the slit 40 is closed by the elastic deformation by pressing from the inner wall of the opening portion of the well 230 and the elastic deformation by the elastic restoring force of the bottom portion 34 of the tubular portion 30.

In accordance with such the septum 1 according to the present embodiment, the elastic deformation by the protrusions 35 extends to the slit 40 provided in a previously opened shape, so that like the conventional typical septum 100, the container such as the well 230 in which the sample is contained can be sealed in a state where the thin tube can be inserted and pulled out. For that, while the insertion of the thin tube into the container and the pulling out of the thin tube from the container are allowed, the evaporation of the component from the container and the intrusion of a contaminant into the container can be suppressed. Therefore, when the container is sealed by the septum 1, accurate and stable analysis is enabled.

In addition, in accordance with the septum 1 according to the present embodiment, since the shape and structure of the slit 40 are different from the shape and structure of the conventional typical septum 100, the manufacturing process of the septum can be simplified.

In the conventional typical septum 100, the slit 140 as the cut is provided in the bottom portion 134 of the tubular portion 130. The slit 140 as the cut is formed by the punching processing that penetrates the punch having the thin straight edge through the bottom portion 134 of the tubular portion 130.

However, at the time of the punching processing, the operation of mounting the resin molded septum 100 on the processing jig and the operation of conveying the septum 100 formed with the slit 140 to the next step are required to be performed in the air. At the time of the punching processing, since a small amount of processing chips is caused, the use of the clean room is inhibited. In addition, anti-rust oil, rust, and the like may adhere to the punch used for the processing.

In the conventional manufacturing process for performing such the punching processing, the septum 100 being manufactured is handled in the air, and comes into contact with the punch to which a foreign substance adheres, so that the septum 100 can be contaminated. For that, after the punching processing, a cleaning step for cleaning the spectrum 100 is required.

In addition, at the time of the punching processing, the individual slits 140 are formed at one time in the bottom portions 134 of the plurality of tubular portions 130 that are arrayed in a matrix. The plurality of slits 140 are formed by the punch in which the straight edges are arrayed in a matrix. In addition, at both end portions of the slit 140 as the cut, crack-like collapse surfaces are formed by the penetration of the thin straight edge.

At the time of such the punching processing, the perforation defect, misalignment, dimension defect, and the like of the slit 140 may be caused. In addition, since both end portions of the slit 140 as the cut form the crack-like collapse surfaces, cracking is likely to proceed at the end portions of the slit 140. When the cleaning step is performed after the punching processing, since a collision force and the like are likely to be applied to the protruding tubular portion 130, the cracking progresses at the end portion of the slit 140, so that the dimension defect of the slit 140 and the tearing of the tubular portion 130 may be caused. For that, after the punching processing or after the cleaning step, a slit inspection step for inspecting all the slits 140 is required.

However, when the cleaning step and the slit inspection step are incorporated into the manufacturing process of the septum, there is a problem that the manufacturing cost of the septum becomes high. When the septum is liquid cleaned, a drying step is also required. For the cleaning step, the drying step, and the slit inspection step, the number of steps and the facility cost are increased. In addition, the slit 140 as the cut is closed substantially completely unless a load is applied from the outside, so that it takes time to perform the inspection in terms of poor visibility. In addition, when even in some of the plurality of slits 140 and the plurality of tubular portions 130, the perforation defect, misalignment, and dimension defect of the slit 140 and the tearing of the tubular portion 130 are caused, the entire septum 100 becomes a defective product, so that there is a problem that the yield in the product unit is deteriorated.

On the contrary, in accordance with the septum 1 according to the present embodiment, since the slit 40 is resin molded in an opened shape, the punching processing step, the cleaning step, and the slit inspection step are not required to be incorporated into the manufacturing process of the septum. Since the slit 40 is resin molded, no processing chips are caused, and the septum 1 can be manufactured in the clean room. The septum 1 being manufactured does not come into contact with the contaminated processing jig and punch, and the handling in the air is reduced, so that the cleaning step is not required. In addition, since the slit 40 is opened in a non-load state, the dimension and the like can be easily inspected. In addition, since the slit 40 is resin molded, the perforation defect, misalignment, and dimension defect of the slit 40 and the tearing of the tubular portion 30 starting from the slit 40 are less likely to be caused. Therefore, in accordance with the septum 1 according to the present embodiment, the manufacturing cost of the septum can be suppressed and the yield in the product unit can be improved on the basis of the peripheral structure of the slit into which the thin tube, such as the capillary, needle, and nozzle 400, is inserted.

In addition, in accordance with the septum 1 according to the present embodiment, the effect of reducing the carry-over of the sample in the automatic analyzer is obtained on the basis of the shape and structure of the tubular portion 30 and the shape and structure of the slit 40.

In the automatic analyzer, when the liquid in the well 230 is aspirated by the thin tube or the liquid is discharged into the well 230 by the thin tube, the liquid may adhere to the side surface and the like of the end portion of the thin tube. When the liquid adherers to the thin tube, when the thin tube is inserted into the different well 230, the brining of the liquid into the different well 230, that is, the carry-over of the liquid, is caused. The occurrence of the carry-over leads to the concentration change in the sample and cross contamination. For that, the removal of the liquid that adheres to the end portion of the thin tube and the cleaning of the end portion of the thin tube are required.

In the conventional typical septum 100, the slit 140 in the bottom portion 134 of the tubular portion 130 is provided as the straight cut. For that, when the thin tube is pulled out from within the well 230, the inner walls of the slit 140 as the cut that are pressed and retreated by pressing from the thin tube attempt to return to the original state by the elastic restoring force to the degree that the inner walls of the slit 140 as the cut come into contact with each other. In such the process, the liquid that adheres to the side surface of the end portion of the thin tube can be wiped away to some degree by the inner walls of the slit 140 as the cut that attempt to return to the original state.

However, the bottom portion 134 of the tubular portion 130 provided with the slit 140 as the cut has a thin wall to the degree that the punch having the thin straight edge penetrates therethrough. In the case of that the inner walls of the slit 140 are thin, when the inner walls are pressed and retreated by pressing from the thin tube, the elastic restoring force of the inner walls that attempt to return to the original state becomes weak. For that, in the conventional typical septum 100, the function of wiping away the liquid that adheres to the side surface of the end portion of the thin tube is not sufficiently obtained. In the technique described in Patent Literature 1, since only the elastic force of the material deformed by pressing from the thin tube is used, the load applied to the side surface of the end portion of the thin tube may be insufficient.

On the contrary, in the septum 1 according to the present embodiment, since the protrusions 35 are formed on the side surfaces of the tubular portion 30, and the slit 40 is elastically deformed so as to be closed from both outer sides in the lateral direction by pressing from the inner wall of the opening portion of the well 230 to the protrusions 35, the elastic restoring force in which the slit 40 attempts to return to the original state can be strengthened as compared with the conventional septum. Since the inner walls of the slit 40 are elastically deformed in the direction in which the inner walls of the slit 40 are closed by pressing to the protrusions 35 before the inner walls of the slit 40 are elastically deformed in the direction in which the inner walls of the slit 40 are opened by pressing from the thin tube, when the thin tube is pulled out from within the well 230, the load by the elastic force with respect to the side surface of the end portion of the thin tube becomes stronger than the conventional septum.

The load by the elastic force applied from the slit 40 to the end portion of the thin tube can be adjusted by adjusting, for example, the shape, length, width, height, arrangement of the protrusion 35 and the thickness and the like of the bottom portion 34 of the tubular portion 30. When the load by the elastic force applied to the end portion of the thin tube is adjusted to strengthen the function of wiping away the liquid that adheres to the side surface of the end portion of the thin tube, the carry-over is reduced, so that the concentration change of the sample and cross contamination can be suppressed.

In addition, in accordance with the septum 1 according to the present embodiment, since the slit 40 is resin molded in a previously opened shape, as compared with the case of the conventional slit 140 as the cut, the durability of the peripheral structure of the slit 40 can be improved. Even when an external force is applied to the protruding tubular portion 30, for example, at the time of mounting the septum 1 or at the time of storing the septum 1, the tearing of the end portion of the slit 40 and the tearing and the like of the tubular portion 30 are reduced, so that the septum 1 having high durability is obtained.

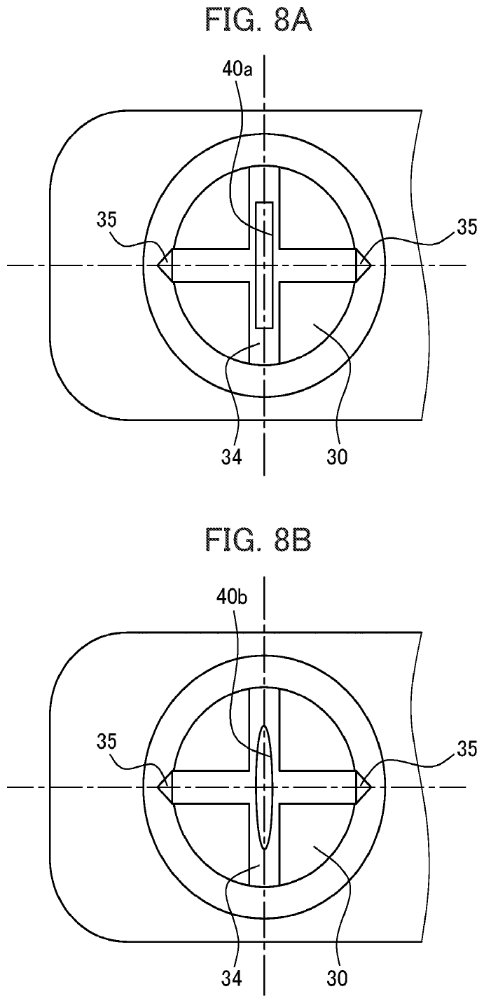

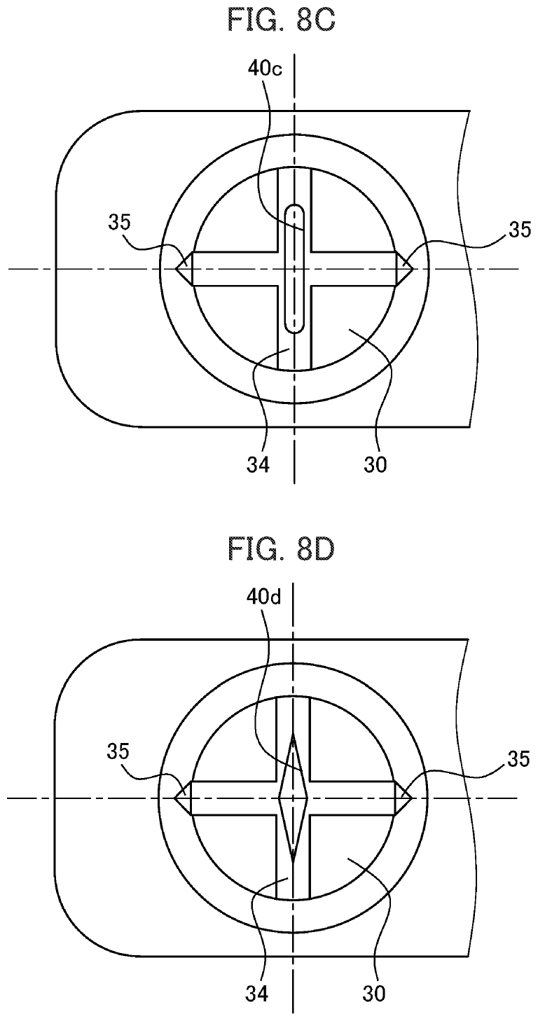

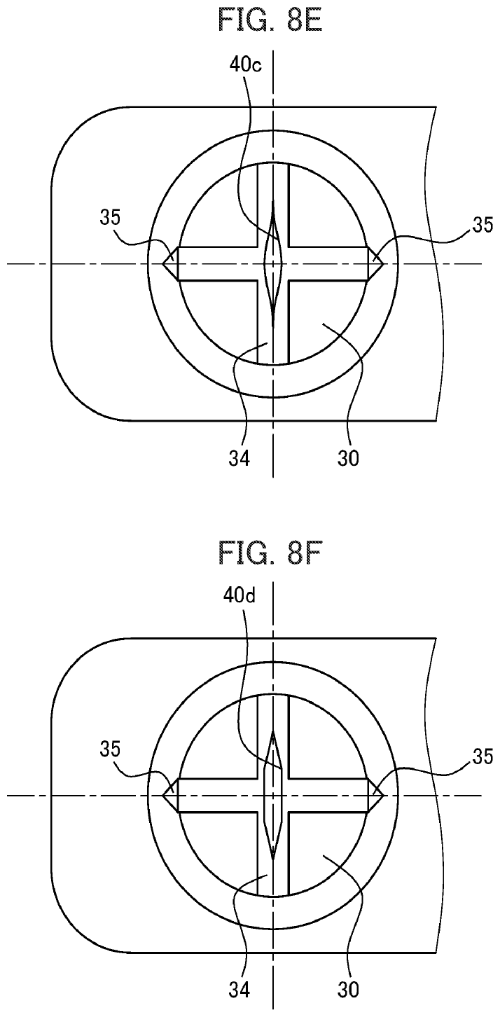

FIGS. 8A to 8F are bottom views of the tubular portion of the septum illustrating the shape examples of the slit.

FIGS. 8A to 8F illustrate the shape examples of the slit 40 in a state where the tubular portion 30 is removed from the opening portion of the container. As illustrated in FIGS. 8A to 8F, the slit 40 in the bottom portion 34 of the tubular portion 30 can be provided so as to be opened in an appropriate flat shape having a large aspect ratio.

FIG. 8A is a diagram illustrating a slit 40a in a rectangular shape. FIG. 8B is a diagram illustrating a slit 40b in an elliptic shape. FIG. 8C is a diagram illustrating a slit 40c in an oval shape. FIG. 8D is a diagram illustrating a slit 40d in a rhombic shape. FIG. 8E is a diagram illustrating a slit 40e in a mouth shape. FIG. 8F is a diagram illustrating a slit 40f in a spear shape.

The slit 40c opened in an oval shape is provided in a shape in which the short sides of a flat rectangular shape are in a semi-circular arc shape. The slit 40e opened in a mouth shape is provided in a flat shape in which two curves in a normal distribution curve shape are combined with each other so as to be closed curves. The slit 40f opened in a spear shape is provided in a flat hexagonal shape.

As illustrated in FIGS. 8A to 8F, the slits 40a, 40b, 40c, 40d, 40e, 40f opened in a flat shape are formed such that the longitudinal direction of each of the slits 40a, 40b, 40c, 40d, 40e, 40f is parallel to the longitudinal direction of the bottom portion 34 of the tubular portion 32.

In bottom view of the tubular portion 30, the protrusions 35 are arranged in the direction perpendicular to the longitudinal direction of the bottom portion 34 of the lower tubular portion 32 with respect to the center portion of the respective long sides of the bottom portion 34 of the lower tubular portion 32. The protrusions 35 are arranged to be line symmetrical on both outer sides with respect to the center axis in the longitudinal direction of each of the slits 40a, 40b, 40c, 40d, 40e, 40f so as to sandwich the center side of each of the slits 40a, 40b, 40c, 40d, 40e, 40f from both outer sides in the lateral direction.

For example, when the inside diameter of the well 230 is 5 mm, the length in the long side direction of each of the slits 40a, 40b, 40c, 40d, 40e, 40f can be provided to be between 2.8 mm and 3.2 mm, both inclusive. In addition, the width in the lateral direction can be provided to be 0.5 mm or less. The height of the protrusion 35, that is, the length in the radial direction in bottom view of the tubular portion 30, can be provided to be between 0.25 mm and 0.4 mm, both inclusive. The thickness of the bottom portion of the tubular portion 30 can be provided to be 1 mm or more and less than 1 mm according to the load and the like by the elastic force applied to the end portion of the thin tube.

As illustrated in FIG. 8A, in accordance with the slit 40a opened in a rectangular shape, there is a demerit that when pressing from the inner wall of the container to the protrusions 35 are applied, openings are left at both end portions in the longitudinal direction of the slit 40a. However, since the molding die for resin molding the slit 40a has a simple shape, there is a merit that the molding die can be easily manufactured. In addition, since the core side of the molding die does not have a thin shape at the position corresponding to the slit 40a, the molding die is less likely to be broken.

As illustrated in FIG. 8B, in accordance with the slit 40b opened in an elliptic shape, since both end portions in the longitudinal direction of the slit 40b have thin shapes, there is a demerit that cracking is likely to be caused. In addition, since the core side of the molding die has thin shapes at the positions corresponding to both end portions of the slit 40b, the molding die is likely to be broken. However, when pressing from the inner wall of the container to the protrusions 35 is applied, openings are less likely to be left at both end portions in the longitudinal direction of the slit 40b, so that there is a merit that high sealing ability is obtained.

As illustrated in FIG. 8C, in accordance with the slit 40c opened in an oval shape, when pressing from the inner wall of the container to the protrusions 35 is applied, there is a demerit that openings are left at both end portions in the longitudinal direction of the slit 40c. However, since the molding die for resin molding the slit 40c has a simple shape, there is a merit that the molding die can be easily manufactured. In addition, since the core side of the molding die does not have a thin shape at the position corresponding to the slit 40c, the molding die is less likely to be broken.

As illustrated in FIG. 8D, in accordance with the slit 40d opened in a rhombic shape, since both end portions in the longitudinal direction of the slit 40d have acute angled shapes, there is a demerit that cracking is likely to be caused. In addition, since the core side of the molding die has acute angled shapes at the positions corresponding to both end portions of the slit 40d, the molding die is likely to be broken. However, when pressing from the inner wall of the container to the protrusions 35 is applied, openings are less likely to be left at both end portions in the longitudinal direction of the slit 40b, so that there is a merit that high sealing ability is obtained.

As illustrated in FIG. 8E, in accordance with the slit 40e opened in a mouth shape, since both end portions in the longitudinal direction of the slit 40e form sharp points, there is a demerit that cracking is likely to be caused. In addition, since the core side of the molding die has sharp points at the positions corresponding to both end portions of the slit 40e, the molding die is likely to be broken. However, when pressing from the inner wall of the container to the protrusions 35 is applied, openings are less likely to be left at both end portions in the longitudinal direction of the slit 40e, so that there is a merit that high sealing ability is obtained.

As illustrated in FIG. 8F, in accordance with the slit 40f opened in a spear shape, since both end portions in the longitudinal direction of the slit 40f have acute angled shapes, there is a demerit that cracking is likely to be caused. In addition, since the core side of the molding die has acute angled shapes at the positions corresponding to both end portions of the slit 40f, the molding die is likely to be broken. However, when pressing from the inner wall of the container to the protrusions 35 is applied, openings are less likely to be left at both end portions in the longitudinal direction of the slit 40f, so that there is a merit that high sealing ability is obtained.

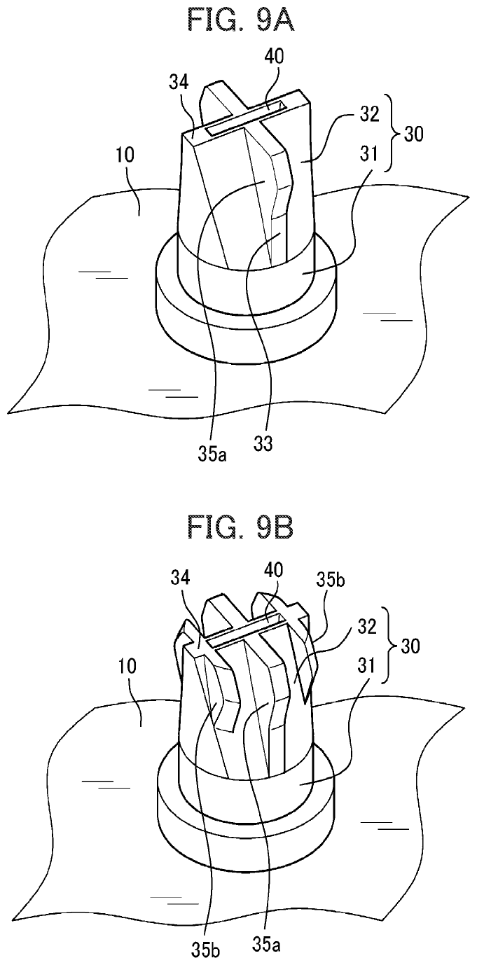

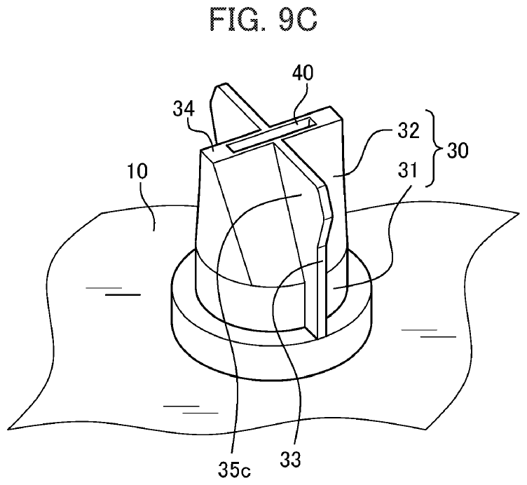

FIGS. 9A to 9C are perspective views of the tubular portion of the septum illustrating the shape examples of the protrusion, seen from below.

FIGS. 9A to 9C illustrate the shape examples of the protrusion 35 provided on the side surfaces of the tubular portion 30. The protrusion 35 protrudes from the side surfaces of the tubular portion 30 to the outside in the radial direction, and can be provided in an appropriate shape and arrangement as long as the slit 40 provided in a previously opened shape is closed by pressing from the inner wall of the container.

FIG. 9A is a diagram illustrating the tubular portion 30 provided with a protrusion 35a in a rib shape. FIG. 9B is a diagram illustrating the tubular portion 30 provided with a protrusion 35b that is auxiliary, together with the rib-shaped protrusion 35a. FIG. 9C is a diagram illustrating the tubular portion 30 provided with a protrusion 35c in a vane shape.

As illustrated in FIG. 9A, the rib-shaped protrusion 35a is provided in a rib shape on the inclined side surfaces of the lower tubular portion 32 so as to protrude from the side surfaces of the lower tubular portion 32 to the outside. The rib-shaped protrusion 35a is provided to be symmetrical on both outer sides in the radial direction with respect to the center axis of the lower tubular portion 32. In side view of the tubular portion 30, the rib-shaped protrusion 35a extends from the lower end portion of the lower tubular portion 32 at which the bottom portion 34 of the lower tubular portion 32 is positioned to the upper end portion of the lower tubular portion 32 at which the boundary with the upper tubular portion 31 is positioned, and is formed as a protrusion having a substantially uniform width.

In bottom view of the tubular portion 30, the rib-shaped protrusion 35a extends from the center portions of the long sides of the bottom portion 34 of the lower tubular portion 32 to both outer sides toward the direction perpendicular to the long sides of the bottom portion 34 of the lower tubular portion 32. In bottom view of the tubular portion 30, the rib-shaped protrusion 35a is provided so as to intersect the center portion of the bottom portion 34 of the lower tubular portion 32 in a cross shape, and is arranged so as to sandwich the center portion of the slit 40 formed in the bottom portion 34 of the lower tubular portion 32 from both outer sides in the lateral direction.

The rib-shaped protrusion 35a is provided in a shape in which on the lower portion side close to the bottom portion 34 of the lower tubular portion 32, the protrusion 35a protrudes to the outside in the radial direction with respect to the main portion of the lower tubular portion 32. The lower portion side of the rib-shaped protrusion 35a protrudes to the outside with respect to the outer circumference surface of the upper tubular portion 31 and the outer circumference surface of the region except for the protrusion 35a of the lower tubular portion 32. In bottom view of the tubular portion 30, the maximum outside diameter of the rib-shaped protrusion 35a is provided to be larger than the outside diameter of the lower tubular portion 32.

When such the rib-shaped protrusion 35a is provided, the elastic fitting ability of the tubular portion 30 with respect to the opening portion of the well 230 of the microplate 200, the slide contacting ability with respect to the inner wall of the opening portion of the well 230, and the closing ability of the slit 40 can be integrally adjusted on the basis of the shape of the rib-shaped protrusion 35a. In addition, as compared with the case where the protrusion 35 is provided in isolation, since the molding die has a simple shape, the molding die can be easily manufactured.

It should be noted that in FIG. 9A, the lower portion side of the rib-shaped protrusion 35a protrudes in an obtuse angled triangular shape in side view of the rib-shaped protrusion 35a. When the rib-shaped protrusion 35a is in such the mountain shape, the rib-shaped protrusion 35a can be less likely to interfere with the opening portion of the well 230 at the time of inserting the tubular portion 30 into the inside of the opening portion of the well 230. Since the rib-shaped protrusion 35a is straightly inserted into the well 230, the closing ability of the slit 40 by the elastic deformation becomes good. Note that the lower portion side of the rib-shaped protrusion 35a can also be provided in a circular arc shape, rectangular shape, trapezoidal shape, and the like.

As illustrated in FIG. 9B, the auxiliary protrusion 35b can also be provided together with the rib-shaped protrusion 35a on the side surfaces of the tubular portion 30. The auxiliary protrusion 35b is provided on the inclined side surfaces of the lower tubular portion 32 so as to protrude from the side surfaces of the lower tubular portion 32 to the outside. Like the rib-shaped protrusion 35a, the auxiliary protrusion 35b is provided to be symmetrical on both outer sides in the radial direction with respect to the center axis of the lower tubular portion 32. In addition, the auxiliary protrusions 35b are provided to be symmetrical on both outer sides with respect to the rib-shaped protrusion 35a so as to sandwich the rib-shaped protrusion 35a. The auxiliary protrusion 35b is formed as a protrusion having a substantially uniform width, and extends to be parallel to the rib-shaped protrusion 35a.

In bottom view of the tubular portion 30, the auxiliary protrusions 35b extend from both end portions of one long side of the bottom portion 34 of the lower tubular portion 32 and both end portions of the other long side of the bottom portion 34 of the lower tubular portion 32 to both outer sides toward the direction perpendicular to the long sides of the bottom portion 34 of the lower tubular portion 32. In bottom view of the tubular portion 30, the auxiliary protrusions 35b are provided so as to intersect the end portions of the bottom portion 34 of the lower tubular portion 32, and are arranged so as to sandwich both end portions of the slit 40 formed in the bottom portion 34 of the lower tubular portion 32 from both outer sides in the lateral direction.

The auxiliary protrusion 35b is provided in a shape in which on the lower portion side close to the bottom portion 34 of the lower tubular portion 32, the protrusion 35b protrudes to the outside in the radial direction with respect to the main portion of the lower tubular portion 32. The auxiliary protrusion 35b protrudes to the outside with respect to the outer circumference surface of the upper tubular portion 31 and the outer circumference surface of the region except for the protrusion 35a of the lower tubular portion 32. In bottom view of the tubular portion 30, the maximum outside diameter of the auxiliary protrusion 35b is provided to be larger than the outside diameter of the lower tubular portion 32.

When such the auxiliary protrusions 35b are provided, when the tubular portion 30 is inserted into the well 230, openings are likely to be left at both end portions in the longitudinal direction of the slit 40, but the openings at both end portions in the longitudinal direction of the slit 40 can be suppressed to be small. When the auxiliary protrusions 35b receive pressing from the inner wall of the opening portion of the well 230, the auxiliary protrusions 35b elastically deform the slit 40 such that both end portions in the longitudinal direction of the slit 40 are collapsed. For that, as compared with the case where the protrusion is provided only at the position where the protrusion intersects the center portion of the bottom portion 34 of the lower tubular portion 32 in a cross shape, the closing ability of the slit 40 can be improved.

It should be noted that in FIG. 9B, the auxiliary protrusion 35b protrudes in an obtuse angled triangular shape in side view of the auxiliary protrusions 35b. When the auxiliary protrusion 35b is in such the mountain shape, the auxiliary protrusion 35b can be less likely to interfere with the opening portion of the well 230 at the time of inserting the tubular portion 30 into the inside of the opening portion of the well 230. Since the auxiliary protrusion 35b is straightly inserted into the well 230, the closing ability of the slit 40 by the elastic deformation becomes good. Note that the auxiliary protrusion 35b can also be provided in a circular arc shape, rectangular shape, trapezoidal shape, and the like.

In addition, in FIG. 9B, the auxiliary protrusions 35b are provided to be parallel to the rib-shaped protrusion 35a, but the auxiliary protrusions 35b can also be provided so as to radially protrude toward the outside in the radial direction of the lower tubular portion 32. In the case of that the auxiliary protrusions 35b are provided to protrude radially, when the auxiliary protrusions 35b receive pressing from the inner wall of the opening portion of the well 230, the auxiliary protrusions 35b can elastically deform the slit 40 such that both end portions in the longitudinal direction of the slit 40 are collapsed toward the center axis side of the tubular portion 30.

As illustrated in FIG. 9C, the vane-shaped protrusion 35c can also be provided on the side surfaces of the tubular portion 30. The vane-shaped protrusion 35c is provided in a vane shape on the side surface of the upper tubular portion 31 and the inclined side surfaces of the lower tubular portion 32 so as to protrude from the side surfaces of the upper tubular portion 31 and the lower tubular portion 32 to the outside. The vane-shaped protrusion 35c is provided to be symmetrical on both outer sides in the radial direction with respect to the center axes of the upper tubular portion 31 and the lower tubular portion 32. In side view of the tubular portion 30, the vane-shaped protrusion 35c extends from the lower end portion of the lower tubular portion 32 at which the bottom portion 34 of the lower tubular portion 32 is positioned to the upper end portion of the upper tubular portion 31, and is formed in a thin plate vane shape having a substantially uniform width.

In bottom view of the tubular portion 30, the vane-shaped protrusion 35c extends from the center portions of the long sides of the bottom portion 34 of the lower tubular portion 32 to both outer sides toward the direction perpendicular to the long sides of the bottom portion 34 of the lower tubular portion 32. In bottom view of the tubular portion 30, the vane-shaped protrusion 35c is provided so as to intersect the center portion of the bottom portion 34 of the lower tubular portion 32 in a cross shape, and is arranged so as to sandwich the center portion of the slit 40 formed in the bottom portion 34 of the lower tubular portion 32 from both outer sides in the lateral direction.

The vane-shaped protrusion 35c is provided in a shape that protrudes to the outside in the radial direction with respect to the main body sides of the upper tubular portion 31 and the lower tubular portion 32. The upper portion side of the vane-shaped protrusion 35c protrudes to the outside in the radial direction with respect to the outer circumference surface of the region except for the protrusion 35c of the upper tubular portion 31. The lower portion side of the vane-shaped protrusion 35c protrudes to the outside with respect to the outer circumference surface of the region except for the protrusion 35c of the lower tubular portion 32. In bottom view of the tubular portion 30, the maximum outside diameter of the vane-shaped protrusion 35c is provided to be larger than the outside diameter on the main body sides of the upper tubular portion 31 and the lower tubular portion 32.

When such the vane-shaped protrusion 35c is provided, the elastic fitting ability of the tubular portion 30 with respect to the opening portion of the well 230 of the microplate 200, the slide contacting ability with respect to the inner wall of the opening portion of the well 230, and the closing ability of the slit 40 can be integrally adjusted on the basis of the shape of the vane-shaped protrusion 35c. In addition, as compared with the case where the rib-shaped protrusion 35a is provided, since the upper portion side of the tubular portion 30 is also easily pressed from the inner wall of the well 230, not only the elastic deformation in the radial direction on the lower portion side of the tubular portion 30, but also the elastic deformation in the axial direction of the tubular portion 30, is easily used.

It should be noted that in FIG. 9C, the lower portion side of the vane-shaped protrusion 35c protrudes in an obtuse angled triangular shape in side view of the vane-shaped protrusion 35c. When the rib-shaped protrusion 35a is in such the mountain shape, the rib-shaped protrusion 35a can be less likely to interfere with the opening portion of the well 230 at the time of inserting the tubular portion 30 into the inside of the opening portion of the well 230. Since the vane-shaped protrusion 35c is straightly inserted into the well 230, the closing ability of the slit 40 by the elastic deformation becomes good. Note that the lower portion side of the vane-shaped protrusion 35c can also be provided in a circular arc shape, rectangular shape, trapezoidal shape, and the like.

It should be noted that although in FIGS. 1 and 2, the microplate 200 is the 96-well microplate, and the septum 1 is for the 96-well microplate, the septum 1 according to the present embodiment may be provided to be for a microplate formed with any number of wells 230. For example, the septum 1 according to the present embodiment may be provided for a 24-well microplate, a 48-well microplate, a 384-well microplate, and the like.

In addition, although in FIGS. 1 and 2, the septum 1 is for the microplate, the septum 1 according to the present embodiment may be provided for a multiple consecutive container including a plurality of arrayed container portions, for example, for a multiple consecutive microtube, a multiple consecutive micro vial, a multiple consecutive migration medium container of the capillary electrophoresis apparatus, and the like.

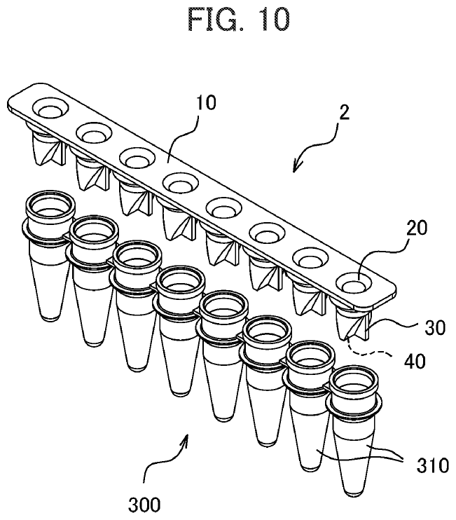

FIG. 10 is a perspective view illustrating the septum according to the embodiment of the present invention and the multiple consecutive microtube.

FIG. 10 illustrates, as an example of the septum according to the present embodiment, a septum 2 for the multiple consecutive microtube, and a multiple consecutive microtube 300 on which the septum 2 is mounted.

The multiple consecutive microtube 300 is used as the container for analysis, examination, experiment, and the like. The multiple consecutive microtube 300 is provided in a structure in which a plurality of microtubes 310 are coupled in parallel. As the materials of the multiple consecutive microtube 300, polyolefin, such as polypropylene, polyethylene, and polystyrene, is used.

The microtube 310 has a circular shape in plan view, and is provided as the container in a substantially columnar shape that is tapered. The upper portion of the microtube 310 is opened upward in a circular shape. In the inside of the microtube 310, a space in a columnar shape that is reduced in diameter downward in a taper shape is formed. Like the well 230 of the microplate 200, the space in the inside of the microtube 310 functions as the container, and the desired liquid or the like is introduced into the space.

In FIG. 10, the multiple consecutive microtube 300 is an 8 consecutive microtube in which 8 microtubes 310 in total are coupled to each other. The microtubes 310 are coupled to each other via a belt-shaped portion coupled to the upper portion. Note that the number of couplings, volume, inside diameter, outside diameter, coupling structure, and the like of the multiple consecutive microtube 300 may be provided under appropriate conditions.

In FIG. 10, the microtube 310 is provided as the container in a substantially columnar shape that is tapered, but the shape of the microtube 310 is not particularly limited. For example, the microtube 310 may be provided as the micro vial type or the like in a substantially columnar shape.

Like the microplate 200, the multiple consecutive microtube 300 has a use as the container that sets the sample to the automatic analyzer including the autosampler. The multiple consecutive microtube 300 can be set to the automatic analyzer by being supported by a rack or the like provided with a supporting hole into which the microtube 310 is inserted.

As illustrated in FIG. 10, like the septum 1 for the microplate, the septum 2 according to the present embodiment includes the main body portion 10 that is formed to be sheet-like, the plurality of hole portions 20 that penetrate through the main body portion 10 upward and downward, the tubular portions 30 that are bottomed and are formed so as to protrude downward from the respective peripheries of the hole portions 20 on the lower surface side of the main body portion 10, and the slits 40 that are formed in the respective bottom portions of the tubular portions 30.

Like the septum 1 for the microplate, the septum 2 according to the present embodiment has the function of sealing the microtube 310 of the multiple consecutive microtube 300 in a state where the thin tube, such as the capillary, needle, and nozzle 400, of the automatic analyzer can be inserted and pulled out. For example, after the sample is introduced into the microtube 310 of the multiple consecutive microtube 300, and before the multiple consecutive microtube 300 is set to the automatic analyzer, the septum 2 is mounted on the upper portion side of the multiple consecutive microtube 300.

Like the septum 1 for the microplate, the main body portion 10, the hole portions 20, and the tubular portions 30 of the septum 2 can be integrally resin molded by the elastomer that exhibits elasticity. Examples of the material of the septum 2 include silicone rubber, fluorocarbon rubber, ethylene propylene diene rubber (EPDM), and the like. The main body portion 10 can be provided to have a width equivalent to the outside diameter of the microtube 310 and a length equivalent to the outside dimension in the coupling direction of the microtube 310.

Like the septum 1 for the microplate, the septum 2 can be provided with a structure unit in which the microtube 310 of the multiple consecutive microtube 300 is sealed in a state where the thin tube, such as the capillary, needle, and nozzle 400, of the automatic analyzer can be inserted and pulled out. The slit 40 of the bottom portion 34 of the tubular portion 30 is provided in a previously opened shape. In addition, the protrusion 35 is provided on the side surface of the tubular portion 30.

Like the septum 1 for the microplate, the septum 2 according to the present embodiment adopts an insertion state where the thin tube, such as the capillary, needle, and nozzle 400, of the automatic analyzer is inserted through the tubular portion 30 into the microtube 310 of the multiple consecutive microtube 300 and a pulling out state where the thin tube is pulled out from the microtube 310 of the multiple consecutive microtube 300 to the outside with respect to the tubular portion 30. The slit that is formed in the bottom portion of the tubular portion 30 is opened and closed by the elastic deformation.

Like the septum 1 for the microplate, the septum 2 according to the present embodiment is provided such that when the pulling out state is shifted to the insertion state, the slit is opened by the elastic deformation of the tubular portion 30 by pressing from the thin tube to allow the insertion of the thin tube. On the other hand, the septum 2 according to the present embodiment is provided such that when the insertion state is shifted to the pulling out state, or in the pulling out state before insertion, the slit is closed by the elastic force of the tubular portion 30 to seal the well 230.

In accordance with such the septum 2, the microtube 310 in which the sample is contained can be sealed by the slit elastically opened and closed in a state where the thin tube can be inserted and pulled out. For that, while the insertion of the thin tube into the microtube 310 and the pulling out of the thin tube from within the microtube 310 are allowed, the evaporation of the component from within the microtube 310 and the intrusion of a contaminant into the microtube 310 can be suppressed. When the microtube 310 is sealed by the septum 2, accurate and stable analysis is enabled.

Like the septum 1 for the microplate, the septum 2 according to the present embodiment is different from the conventional typical septum 100 in the shape and structure of the tubular portion 30 that is bottomed and is formed so as to protrude downward of the main body portion 10 and the shape and structure of the slit 40 that is formed in the bottom portion 34 of the tubular portion 30. In addition, in relation to the difference between these shapes and structures, the sealing method of the container and the manufacturing process of the septum are different.

Like the septum 1 for the microplate, in the septum 2 according to the present embodiment, the slit 40 in the bottom portion 34 of the tubular portion 30 is provided in a previously opened shape. In addition, the protrusion 35 is provided on the side surface of the tubular portion 30. As illustrated in FIGS. 8A, 8B, 8C, 8D, 8E, and 8F, the slit 40 can be provided so as to be opened in a flat shape having a large aspect ratio, such as a rectangular shape, elliptic shape, oval shape, rhombic shape, mouth shape, and spear shape. As illustrated in FIGS. 9A, 9B, and 9C, the protrusion 35 can be provided as the rib-shaped protrusion 35a, a combination of the rib-shaped protrusion 35a and the auxiliary protrusions 35b, the vane-shaped protrusion 35c, and the like.

In accordance with the septum according to the above present embodiment, since the manufacturing process of the septum is simplified on the basis of the peripheral structure of the slit, the manufacturing cost of the septum can be suppressed, and the yield in the product unit can be improved. For that, as compared with the septum provided with the conventional slit as the cut, the septum can be provided at low cost. In addition, since the carry-over of the sample in the automatic analyzer can be reduced, more accurate analysis can be performed. In addition, as compared with the septum provided with the conventional slit as the cut, a product having high durability around the slit is obtained.

Although the present invention has been described above, the present invention is not limited to the embodiment, and various modifications can be made in the scope not departing from the purport of the present invention. For example, the present invention is not necessarily required to include all the structures included in the embodiment. A portion of the structure of an embodiment can be replaced with other structures, a portion of the structure of an embodiment can be added to other forms, and a portion of the structure of an embodiment can be omitted.

Although the septum according to the embodiment is for the microplate and the multiple consecutive microtube, the septum according to the embodiment is applicable, not only to the microplate and the multiple consecutive microtube, but also to a multiple consecutive container that integrally includes a plurality of arrayed containers or a plurality of arrayed container portions. The volume of the container is not limited to the micro order, and is applicable to the container and the container portion having an appropriate volume. The septum may be a single accessary component and be stacked on the plate at the time of use, and may be integrated with the lower surface side of a cover member having high rigidity.

### LIST OF REFERENCE SIGNS

1 septum
2 septum
10 main body portion
20 hole portion
30 tubular portion
31 upper tubular portion
32 lower tubular portion
33 rib
34 bottom portion
35 protrusion
40 slit
100 septum
110 main body portion
120 hole portion
130 tubular portion
140 slit
200 microplate
210 concave portion
220 outer frame
230 well (container)
231 upper portion
232 lower portion
300 multiple consecutive microtube
310 microtube (container)
400 nozzle (thin tube)

1. A septum comprising: a plurality of tubular portions that are fittable to the inner sides of the opening portions of a plurality of arrayed containers; and slits that are formed in the respective bottom portions of the tubular portions,
wherein the septum adopts an insertion state where in a state where each of the tubular portions is fitted in the opening portion, a thin tube that aspirates or discharges a liquid from within or into the container is inserted through the tubular portion into the container and a pulling out state where the thin tube is pulled out from within the container to the outside with respect to the tubular portion,
wherein when the pulling out state is shifted to the insertion state, the slit is opened by the elastic deformation of the tubular portion by pressing from the thin tube to allow the insertion of the thin tube, and
wherein when the insertion state is shifted to the pulling out state, the slit is closed by the elastic force of the tubular portion to seal the container, the septum wherein
the tubular portion has a protrusion that protrudes from the side surface of the tubular portion to the outside in the radial direction, and
wherein in a state where the tubular portion is removed from the opening portion, the slit is provided in an opened shape in which the inner walls of the slit are not abutted onto each other, and in a state where the tubular portion is fitted to the inner side of the opening portion, the protrusion receives pressing from the inner wall of the container, and the slit is closed by the elastic deformation of the tubular portion by the pressing to seal the container.

2. The septum according to claim 1,
wherein the slit is provided so as to be opened in a rectangular shape, elliptic shape, oval shape, rhombic shape, mouth shape, or spear shape.

3. The septum according to claim 1,
wherein the tubular portion has an upper tubular portion provided in a cylindrical shape, and a lower tubular portion that is provided in a shape in which both outer sides in the radial direction of a bottomed cylindrical shape are diagonally cut away so as to have a V-shape in side view, and
wherein the bottom portion of the tubular portion is the bottom portion of the lower tubular portion having a rectangular shape in bottom view of the tubular portion.

4. The septum according to claim 3,
wherein the slit is formed in the bottom portion of the lower tubular portion having a rectangular shape in bottom view of the tubular portion so as to be parallel to the longitudinal direction of the bottom portion of the lower tubular portion, and
wherein the protrusion is arranged so as to sandwich the center portion of the slit from both outer sides in the lateral direction of the slit.

5. The septum according to claim 4,
wherein the protrusion is provided in a rib shape that protrudes from the side surface of the lower tubular portion to the outside, or in a vane shape that protrudes from the side surfaces of the upper tubular portion and the lower tubular portion to the outside.

6. The septum according to claim 1,
wherein the container is a well provided on a microplate, and
wherein the septum is for the microplate.

7. The septum according to claim 1,
wherein the container includes a plurality of microtubes that are coupled to each other, and
wherein the septum is for a multiple consecutive microtube in which the plurality of microtubes are coupled to each other.

8. The septum according to claim 1,
wherein the thin tube is a capillary, needle, or nozzle included in an automatic analyzer.
